(19) United States
(12) Patent Application Publication
(10) Pub. No.: US 2026/0194175 A1
(43) Pub. Date: Jul. 9, 2026

(54) PIPE CLAMPING APPARATUS

(71) Applicant: KIBOSH LTD, Galashiels (GB)

(72) Inventor: Ross DICKINSON, Galashiels (GB)

(73) Assignee: KIBOSH LTD, Galashiels (GB)

(21) Appl. No.: 19/133,825

(22) PCT Filed: Nov. 29, 2023
(86) PCT No.: PCT/GB2023/053092

§ 371 Date: May 29, 2025

(30) Foreign Application Priority Data
Nov. 30, 2022 (GB) 2218034.3

(51) Int. Cl. F16L 55/17; F16L 55/103

(52) U.S. Cl. CPC F16L 55/1715; F16L 55/103

(57) ABSTRACT

A pipe clamping apparatus for containing a fluid leaking from a pipe is provided. The pipe clamping apparatus comprises first and second housing members (12,14) connected by a hinge (16) and suitable for placing on a surface of a pipe (24) to define an enclosed cavity (40) between the first and second housing members and the surface of the pipe in a fully closed position of the pipe clamping apparatus. A clamping assembly is operable to hold the first and second housing members (12,14) in a sealed engagement with the pipe (24) to seal the enclosed cavity (40) and provide a fluid tight seal between the housing members and the pipe. The first and second housing members (12,14) are each provided with mutually engaging sealing surfaces (20) adapted to provide a fluid tight seal between the first and second housing members, at least one of the mutually engaging sealing surfaces having a first resilient seal means (72a) secured thereto. The first and second housing members (12,14) are also each provided with pipe sealing surfaces (22) adapted to provide a fluid tight seal between a surface of the pipe (24) and the housing member (12,14), each cylindrical sealing surface having a second resilient seal means (72b) secured thereto. The first and second housing members (12, 14) are each provided with part-cylindrical friction surfaces (23) separate from the pipe sealing surfaces (22) and adapted to provide a frictional resistance against axial and/or rotational movement of the pipe clamping apparatus relative to the pipe (24), each cylindrical friction surface having a resilient friction means (68) secured thereto. A second pipe clamping apparatus for application to a pipe for isolating the pipe by freezing fluid carried in the pipe is also provided, this second clamping apparatus having a similar set of components to that of the first clamping apparatus.

### FIELD OF THE INVENTION

The present invention relates to the repair and maintenance of pipes used for conveying fluids. In particular, the invention relates to a pipe clamp which can be used to repair a leak in a pipe or to isolate a section of pipe to enable repair or maintenance work to be carried out.

### BACKGROUND TO THE INVENTION

Pipes are a common feature of many systems in which fluids are transferred from one location to another. Such systems include domestic water systems, domestic heating systems, vehicle cooling systems, industrial pipework systems, mains supply and service networks. Leaking or burst pipes may cause damage both to the system in which the pipe is employed and to the surrounding environment. For example, a leaking pipe in a heating system may cause a reduction in pressure and loss of water in the system, which may cause damage to a boiler. Additionally, the leaking pipe may result in water from the heating system causing significant damage to an area of a building in the proximity of the leaking.

In systems that are under pressure, e.g. a heating system or a mains water supply, it is desirable to repair a burst or leaking pipe quickly to minimise the amount of damage arising from the fluid leaking from the pipe. In certain circumstances, a temporary containment of the leak is desirable before the required steps are taken to undertake a more permanent repair. This can reduce inconvenience and loss of containment and production. When used with water carrying systems it can reduce water waste.

WO 2011/045608 A1 describes a pipe clamp which can be used to effect a temporary repair of a pipe in a domestic water supply or heating system by containing fluid leaking from the pipe. The clamp comprises a hinged housing which can be placed around the outer surface of the pipe to define a cavity between the housing and the pipe. The housing includes a clasp and a lever which is operable to hold the housing in sealed engagement with the pipe to produce a sealed joint therebetween.

It is an object of the present invention to provide an improved clamp which can be used in both domestic and industrial applications. It is a further object of the invention to provide a clamp which can be applied to a pipe in both domestic and industrial applications to isolate a section of pipe or an entire pipe system.

### SUMMARY OF THE INVENTION

### Pipe Repair Embodiment

According to a first aspect of the present invention there is provided a pipe clamping apparatus for containing a fluid leaking from a pipe, the pipe clamping apparatus comprising:
first and second housing members connected by a hinge and suitable for placing on a surface of a pipe to define an enclosed cavity between the first and second housing members and the surface of the pipe in a fully closed position of the pipe clamping apparatus, and
a clamping assembly operable to hold the first and second housing members in a sealed engagement with the pipe to seal the enclosed cavity and provide a fluid tight seal between the housing members and the pipe,
characterised in that
the first and second housing members are each provided with mutually engaging sealing surfaces adapted to provide a fluid tight seal between the first and second housing members, at least one of the mutually engaging sealing surfaces having a first seal groove,
the first and second housing members are each provided with pipe sealing surfaces adapted to provide a fluid tight seal between a surface of the pipe and the housing member, each cylindrical sealing surface having a second seal groove, and
the first and second housing members are each provided with part-cylindrical friction surfaces separate from the pipe sealing surfaces and adapted to provide a frictional resistance against axial movement of the pipe clamping apparatus relative to the pipe, each cylindrical friction surface having a resilient friction means secured thereto.

The pipe clamping apparatus may further comprise a first resilient seal means located in the first seal groove, and a second resilient seal means located in the second seal groove.

The resilient friction means may have a greater stiffness than the first and second resilient seal means.

By holding the housing members in sealed engagement with the pipe, the clamping assembly compresses the mutually engaging sealing surfaces of the housing members together with the resilient seal means therebetween. At the same time the clamping assembly urges the cylindrical pipe sealing surfaces against the surface of the pipe, so that there is a fluid-tight seal provided between the housing and the surface of the pipe. The production of the seal serves to contain any fluid leakage from the pipe and therefore prevents the escape of fluid, such as a gas or a liquid, from the cavity formed within the pipe clamping apparatus.

The use of first and second housing members allows the pipe clamping apparatus to be fitted entirely around the outer circumference of a section of damaged or leaking pipe. This provides the advantage that the pipe clamping apparatus may be used to provide a seal around bursts, perforations or cuts which are present about a section of the circumference of a pipe, or which have resulted in a complete break, hole or cut in a pipe.

The resilient friction means serves the function of holding the pipe clamping apparatus securely on the pipe, while the resilient seal means serves the function of providing a fluid-tight seal. Because the functions are different, different materials can be used. The properties of the resilient friction means can be optimised to minimise movement of the pipe clamping apparatus on the pipe, even where the pipe is subject to vibration or other external forces. The properties of the resilient seal means can be optimised to minimise leakage, without having to select a material which can accommodate and resist vibration or other forces which may urge the pipe clamping apparatus to be displaced along the pipe.

The resilient friction means may comprise a metal or ceramic friction means. The resilient friction means may comprise an arcuate strip of resilient material having a Shore A hardness in the range 50 to 150, preferably 70 to 100. The strip may be bonded to the housing. The resilient material may be of natural or synthetic rubber, rope, resin, metal coil, or fire resistant barrier material. The resilient friction means may be discontinuous in the circumferential direction in the closed position of the pipe clamping apparatus, to allow the passage of fluid therethrough between the pipe and the cylindrical friction surfaces. Such a Shore A hardness has been found to provide satisfactory resistance against movement of the pipe clamping apparatus along the pipe, even when the pipe is subject to vibration.

The first and second resilient seal means may comprise one or more strips of resilient material having a Shore A hardness in the range 30 to 90, preferably 40 to 80. The first and second resilient seal means may be continuous to provide a continuous fluid tight sealing means between the pipe and the pipe clamping apparatus. Such a Shore A hardness has been found to provide a satisfactory fluid tight joint, even though the seal means would not be able to resist severe vibratory movement by itself. The first and second resilient seal means may comprise one more elastomeric seals of a material suitable to withstand the fluid in the pipe. The first and second resilient seal means may comprise natural or synthetic rubber or foam material.

The resilient material of the resilient friction means preferably has a Shore A hardness greater than that of the resilient material of the first and second resilient seal means. The resilient friction means is therefore stiffer than the resilient seal means, and serves to hold the pipe clamping apparatus in place while preventing excessive shear or deflection of the less stiff resilient seal means, so that the resilient seal means remains fluid-tight and performs its primary function of sealing.

One of the first and second housing members may be provided with a vent valve allowing venting of fluid from the enclosed cavity. A vent valve as referred to in this specification includes any valve which can be used for pressure relief. For example the pipe clamping apparatus may be used to repair a leak in a pressurised pipe. After installation of the pipe clamping apparatus to seal the enclosed cavity and provide a fluid tight seal between the housing members and the pipe, the vent valve may be opened to release the pressure in the pipe, and/or to check internal pressure and/or to check or test the contents of the pipe, and/or to allow safe opening and removal of the pipe clamping apparatus from the pipe.

The internal surfaces of the first and second housing members which form the outer wall of the cavity may be substantially semi-cylindrical in shape. The diameter of the cylindrical sealing surfaces is approximately equal to the external diameter of the pipe. The diameter of the semi-cylindrical internal surfaces is greater than the external diameter of the pipe, and may be at least 1.5 times the diameter of the pipe, or in one embodiment at least 1.8 times the diameter of the pipe.

The cavity formed between the housing and the surface of the pipe allows the housing to be fitted over a section of leaking or burst pipe where there is an external fitting, such as a joining collar, union, or where the outer wall is protruding, or where the diameter of the pipe has increased due to swelling or bulging, or where the exterior of the pipe is corroded, or where a weld joint in the pipe has failed. The enclosed cavity therefore serves to encapsulate the fitting or protrusion or swelling of the outer wall of the pipe and enhances the pipe clamping apparatus with the ability to form a fluid tight seal to contain a leak.

### Pipe Freezing Embodiment

According to a second aspect of the present invention there is provided a pipe clamping apparatus for application to a pipe for isolating the pipe by freezing fluid carried in the pipe, the pipe clamping apparatus comprising:
first and second housing members connected by a hinge and suitable for placing on a surface of a pipe to define an enclosed cavity between the first and second housing members and the surface of the pipe, and
a clamping assembly operable to hold the first and second housing members in a sealed engagement with the pipe to seal the enclosed cavity and provide a fluid tight seal between the housing members and the pipe,
characterised in that
one of the first and second housing members is provided with an inlet for attachment to a source of liquid refrigerant, the inlet being in communication with the enclosed cavity,
one of the first and second housing members is provided with an outlet for removal of evaporated liquid refrigerant, the outlet being in communication with the enclosed cavity, and
the cavity contains a heat reflecting material and an absorbent material adapted to hold and at least partially retain liquid refrigerant introduced into the cavity through the inlet, the absorbent material being located in use between the heat reflecting material and the pipe.

The heat reflecting material may selected from the group comprising a foil and a surface coating.

The absorbent material allows slower release and evaporation of the liquid refrigerant introduced into the cavity. The absorbent material is preferably in contact and/or close engagement with the pipe wall so that the evaporating liquid refrigerant more effectively freezes the pipe and its contents.

The first and second housing members may each be provided with mutually engaging sealing surfaces adapted to provide a fluid tight seal between the first and second housing members, at least one of the mutually engaging sealing surfaces having a first resilient seal means secured thereto.

The first and second housing members may each be provided with cylindrical sealing surfaces adapted to provide a fluid tight seal between a surface of the pipe and the housing member, each cylindrical sealing surface having a second resilient seal means secured thereto.

By holding the housing members in sealed engagement with the pipe, the clamping assembly may compress the mutually engaging sealing surfaces of the housing members together with the resilient seal means therebetween. At the same time the clamping assembly may urge the cylindrical sealing surfaces against the surface of the pipe, so that there is a fluid-tight seal provided between the housing and the surface of the pipe. The production of the seal serves to contain the liquid refrigerant introduced into the cavity formed within the pipe clamping apparatus.

The use of first and second housing members allows the pipe clamping apparatus to be fitted entirely around the outer circumference of a section of pipe, even if there are local projections on the outer surface of the pipe.

The absorbent material may be a foam, a sponge like material, mineral wool, or a glass wool. The absorbent material may be a foil backed mineral wool, such as Rockwool®. If the absorbent material is foil backed, the foil is preferably placed adjacent to the housing member, so that in use the absorbent material is adjacent to and in close engagement with the pipe. This retains and slowly releases the liquid refrigerant next to the pipe and ensures that the pipe is cooled as quickly as possible, and remains as cool as possible, while providing efficient use of the liquid refrigerant and reducing waste.

The heat reflecting material may be a reflective membrane with high thermal performance, a cryogenic foil, a cryogenic paper, a cryogenic foil/paper composite, an aluminium foil or similar. A suitable heat reflecting foil is Reflectashield® manufactured by Proctor Group. An alternative heat reflecting material which may be used is an aerogel insulation product ArmaGel® DT, manufactured by Armacell. In use the heat reflecting material may line the internal walls of the housing members.

Each of the first and second housing members may be provided with an inlet for attachment to a source of liquid refrigerant, each inlet being in communication with the enclosed cavity. The inlets may each be provided with an inlet closure, so that they can be selectively opened. This gives an operator a choice of inlets for attachment to a source of liquid refrigerant, in case one of the inlets is difficult to access in use.

Each of the first and second housing members may be provided with an outlet for removal of liquid refrigerant, the outlet being in communication with the enclosed cavity. The outlets may each be provided with an outlet closure, so that they can be selectively opened. This gives an operator a choice of outlets for attachment to an outlet pipe, in case one of the outlets is difficult to access in use.

The heat reflecting foil may be attached to an inner surface of the first and second housing members. The heat reflecting foil may be provided with apertures corresponding to the one or more inlets and one or more outlets.

The absorbent material may be attached to an inner surface of the heat reflecting foil. The absorbent material may be provided with apertures corresponding to the one or more inlets. The absorbent material may extend across and at least partially cover the one or more outlets.

The inner surface of the first and second housing members may be provided with local projections, such as pins or dowels, at least partially surrounding each outlet. The purpose of the projections is to provide a clearance between the absorbent material and the outlet so that the absorbent material does not block the outlet. This is particularly necessary if the absorbent material is a foil-backed mineral wool, since without the local projections the foil backing may block the outlet. Alternatively, a ribbed or textured foil may be used which provides clearance for exiting gas or fluid.

Preferably the liquid refrigerant is a liquid gas with a boiling temperature of less than −70° C., preferably less than −150° C. A suitable liquid refrigerant is liquid nitrogen. Liquid carbon dioxide may also be used.

The first and second resilient seal means comprise a cellular foam material, such as nitrile rubber. A suitable material is Armaflex® insulation tape. The first resilient seal means may be provided on one or both of the mutually engaging sealing surfaces.

The pipe clamping apparatus may further comprise an insulated jacket which substantially surrounds the first and second housing members.

The pipe clamping apparatus may further comprise an insulated inlet pipe adapted to be connected to a source of liquid refrigerant and to the inlet for conveying liquid refrigerant to the inlet.

The pipe clamping apparatus may further comprise an insulated outlet pipe connected to the outlet at its first end and in communication with a cavity between the insulated jacket and the first and second housing members at its second end.

### Both Embodiments

According to both the first and second aspects the clamping assembly may comprise:
a linkage member pivotally connected at a first pivot axis to the first housing member,
a clasp arm pivotally connected to the linkage member at a second pivot axis parallel to and spaced from the first pivot axis, and
a detent portion provided on the second housing member, wherein the clasp arm comprises a lever portion and a latch portion, the lever portion being operable to engage the latch portion with the detent portion to hold the first and second housing members in the fully closed position of the pipe clamping apparatus.

The clamping assembly may comprise a plurality of parallel linkage members, preferably two linkage members, pivotally connected at the first pivot axis to the first housing member.

The clamping assembly may comprise a plurality of detent portions, preferably two detent portions, provided on the second housing member. The clasp arm may comprise a plurality of latch portions, the lever portion being operable to engage each latch portion with a corresponding detent portion. Having more than one linkage members and detent portions ensures that the clamping effect of the clamping assembly is applied uniformly along the length of the pipe clamping apparatus.

The lever portion of the clasp arm is preferably operable in an over-centre locking action to hold the first and second housing members in the fully closed position of the pipe clamping apparatus.

The lever portion of the clasp arm is preferably further operable in a non-locking action to engage the latch portion with the detent portion to hold the first and second housing members in a partially closed position of the pipe clamping apparatus which allows the pipe clamping apparatus to be moved along the pipe. In the partially closed position the pipe clamping apparatus is held on the pipe such that it cannot fall off the pipe, making installation of the pipe clamping apparatus easier and safer.

The pipe clamping apparatus may further comprise a locking mechanism operable to prevent movement of the clamping assembly when the pipe clamping apparatus is in the fully closed position. The locking mechanism may comprise a screw member provided in a first threaded aperture on the clasp arm which is engageable with a second threaded aperture provided on the first housing member. The second threaded aperture may be provided on a lug on the first housing member to which the linkage member is pivotally connected at the first pivot axis. The screw member may be a grub screw. Once the clamping assembly has been operated to hold the first and second housing members in the fully closed position of the pipe clamping apparatus, the first and second threaded apertures are aligned and the screw member can be screwed through the first threaded aperture into the second threaded aperture, thereby preventing accidental opening of the pipe clamping apparatus.

The lever portion may comprise a handle. The handle may be operable by hand to effect closure of the pipe clamping apparatus. The lever portion may comprise a tool aperture, for example a slot, suitable for insertion of a lever tool to enable operation of the clamping assembly by a lever tool. The lever portion may comprise a tool receiving flange at its edge furthest from the second pivot axis. The tool receiving flange may have planar upper and lower surfaces and a constant thickness, suitable for being engaged by the jaws of a spanner, wrench, adjustable spanner or other suitable tool to enable operation of the clamping assembly by the spanner, wrench or tool. The tool aperture and/or the tool receiving flange enable an operator to apply a larger lever force to close or open the clamping assembly.

### DETAILED DESCRIPTION

The present invention will now be described with reference to the following figures as described briefly below, which are provided for the purpose of illustration and are not intended to be construed as being limiting on the present invention:

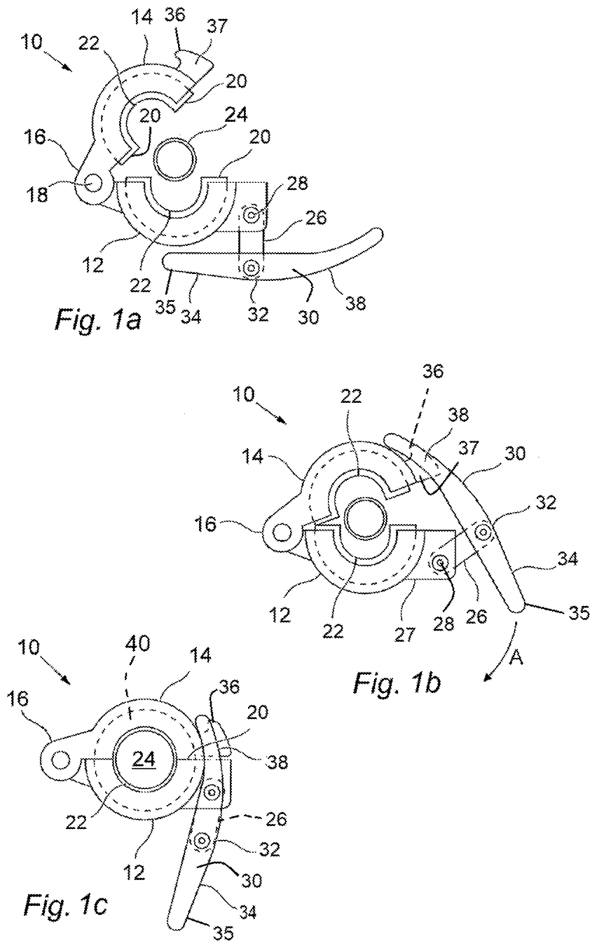

FIGS. 1a, 1b and 1c are schematic side elevations of a pipe clamping apparatus according to a first embodiment of the invention in an unfastened configuration, in a partially fastened configuration and in a fully closed configuration respectively;

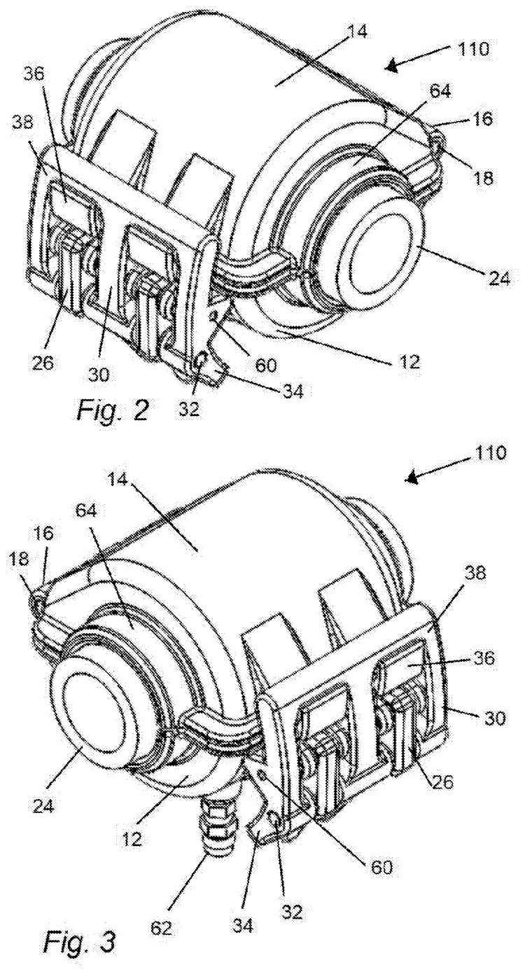

FIG. 2 is a perspective view of a pipe clamping apparatus in a fully closed configuration according to a second embodiment of the invention in which the pipe clamping apparatus is used for pipe repair;

FIG. 3 is a further perspective view of the pipe clamping apparatus of FIG. 2 in a fully closed configuration;

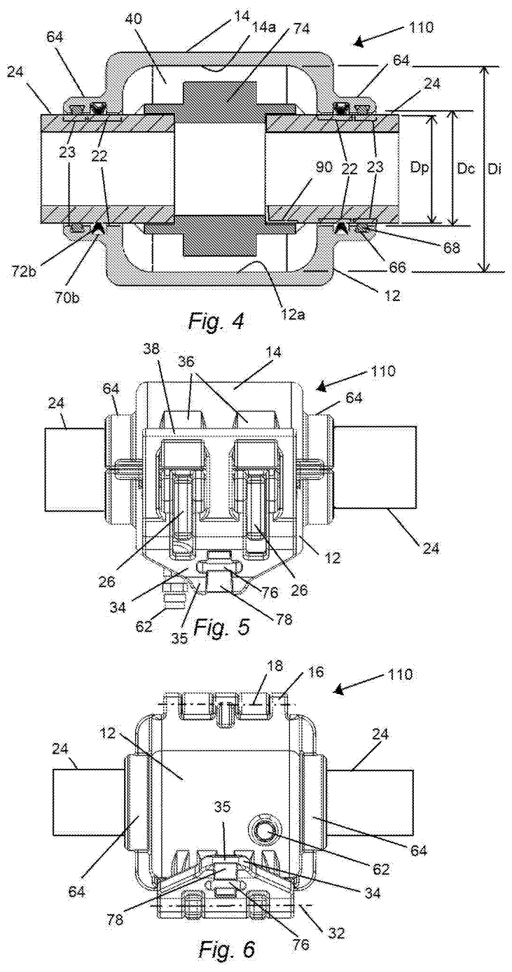

FIG. 4 is a longitudinal sectional view of the pipe clamping apparatus of FIG. 2 in a fully closed configuration;

FIG. 5 is a front elevation of the pipe clamping apparatus of FIG. 2 in a fully closed configuration;

FIG. 6 is a bottom view of the pipe clamping apparatus of FIG. 2 in a fully closed configuration;

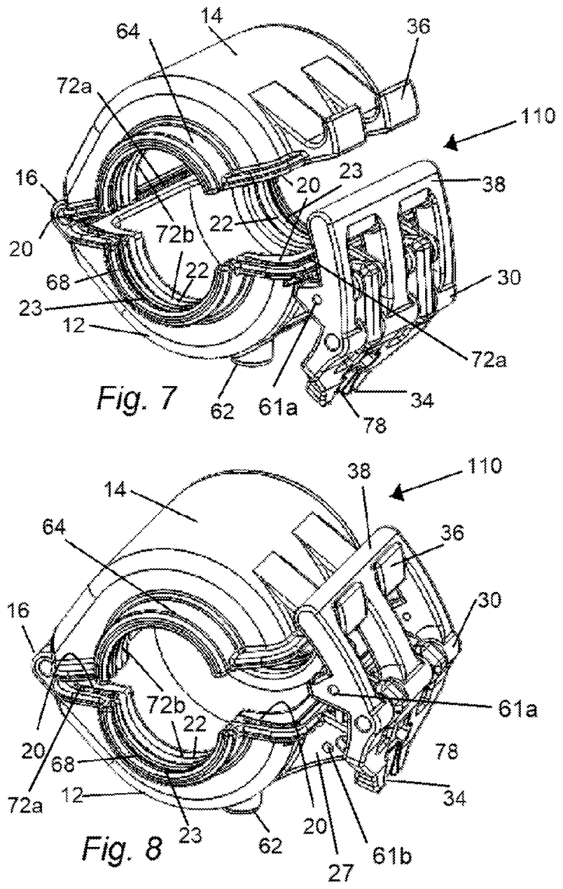

FIG. 7 is a perspective view of the pipe clamping apparatus of FIG. 2 in an open or unfastened configuration;

FIG. 8 is a perspective view of the pipe clamping apparatus of FIG. 2 in a partially fastened configuration;

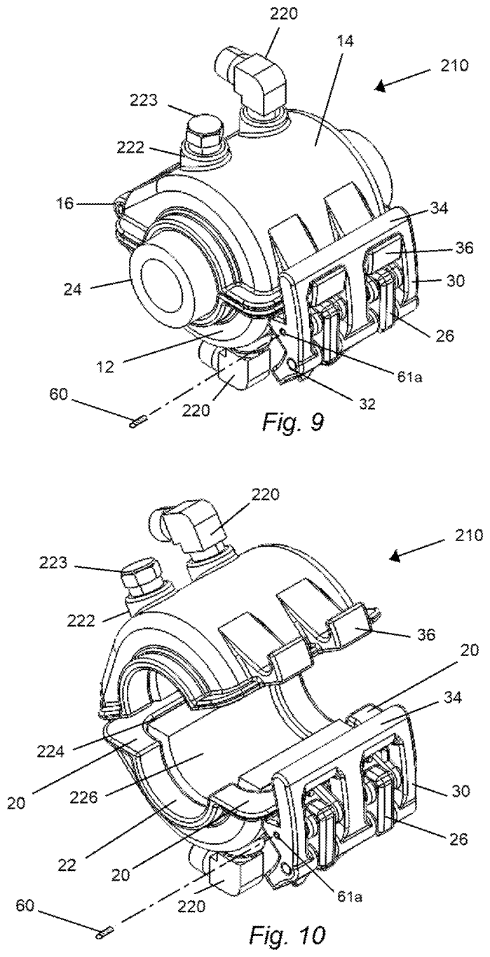

FIG. 9 is a perspective view of a pipe clamping apparatus in a fully closed configuration according to a third embodiment of the invention in which the pipe clamping apparatus is used for freezing a pipe and the fluid therein;

FIG. 10 is a further perspective view of the pipe clamping apparatus of FIG. 9 in an open configuration;

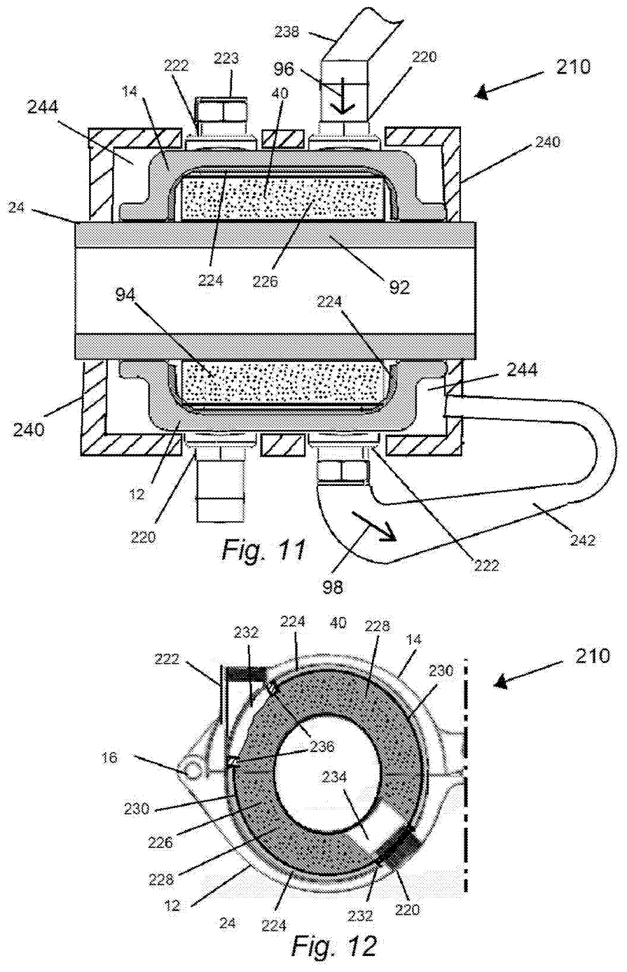

FIG. 11 is a sectional view of the pipe clamping apparatus of FIG. 9 in a fully closed configuration;

FIG. 12 is a cross sectional view of the pipe clamping apparatus of FIG. 11;

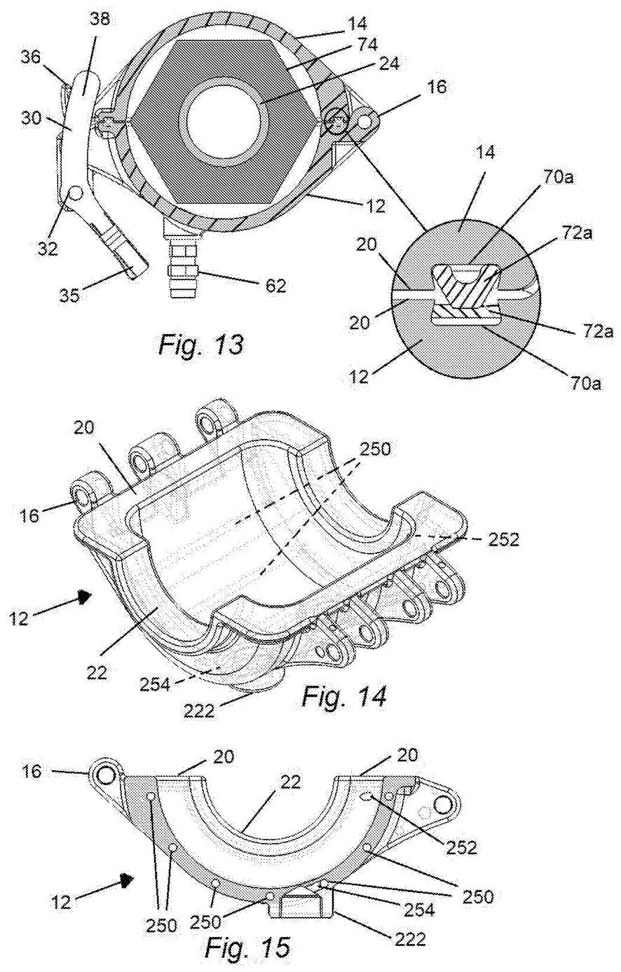

FIG. 13 is a transverse sectional view of the pipe clamping apparatus of FIG. 2 in a fully closed configuration, with an enlarged view of the longitudinal mutually engaging sealing surfaces;

FIG. 14 is a perspective view of a first housing member which can be used in the a pipe clamping apparatus of FIG. 9; and

FIG. 15 is a cross sectional view of the housing member of FIG. 14.

The present invention comprises a pipe clamping apparatus 10, 110, 210 which can be fitted around a pipe 24, either to repair the pipe or to isolate the pipe.

### Operation of Clamping Assembly

By way of example, a possible way of operating the pipe clamping apparatus is illustrated schematically in FIGS. 1a to 1c. The pipe clamping apparatus 10 includes first and second housing members 12, 14 connected by a hinge 16, a clamping assembly 26, 30, 36 operable to hold the first and second housing members 12, 14 in a sealed engagement with the pipe 24 to seal the enclosed cavity and provide a fluid tight seal between the housing members 12, 14 and the pipe.

The first and second housing members 12, 14 are each provided with planar mutually engaging sealing surfaces 20 adapted to provide a fluid tight seal between the first and second housing members 12, 14, and with cylindrical sealing surfaces 22 adapted to provide a fluid tight seal between a surface of the pipe 24 and the housing member 12, 14.

In FIG. 1a the pipe clamping apparatus 10 is in a fully open configuration, adjacent to a pipe 24, which has been ruptured or which it is required to isolate. The pipe clamping apparatus 10 is positioned such that the cylindrical pipe sealing surfaces 22 at each end of the closure device are located either side of the part of the pipe which is ruptured or which is to be isolated.

As shown in FIG. 1a, the pipe clamping apparatus 10 is closed around the pipe 24 by the relative rotation of the first and second housing members 12, 14 about the hinge 16. A pin 18 connects the first and second housing members 12, 14 to form the hinge 16. A linkage member 26 is connected at its first end by a first pivot 28 on a first pivot axis to a clasp arm retaining lug 27 on the first housing member 12. A clasp arm 30 is connected by a second pivot 32 on a second pivot axis parallel to the first pivot axis to the second end of the linkage member 26. A user can use the handle 35 on the lever portion 34 of the clasp arm 30 to close the clasp arm 30, so that the clasp arm 30 and linkage member 26 move to the position shown in FIG. 1b.

In FIG. 1b the clasp arm 30 has been moved in a direction toward the second housing member 14 and the clasp arm detent 36 provided on a detent lug 37 on the body of the second housing member 14. The latch portion 38 of the clasp arm 30 engages with the clasp arm detent 36. In this partially fastened configuration, or initial closed position, of the pipe clamping apparatus 10, the pipe clamping apparatus 10 is prevented from opening by the engagement of the latch portion 38 with the detent portions 36, but the clamping assembly, which comprises the linkage member 26, clasp arm 30 and detent 36, is not in a fully closed position, and does not yet hold the pipe clamping apparatus 10 in sealed engagement with the pipe 24. Therefore the pipe clamping apparatus 10 may safely attached to the pipe 24 in the initial closed position, while still allowing the pipe clamping apparatus 10 be moved along the length of the pipe 24. This is advantageous in circumstances of a high pressure leak. In such conditions it may be problematic to close the pipe clamping apparatus 10 around the leak in the pipe as the high pressure leak may apply a force to keep the pipe clamping apparatus 10 open. Advantageously, the pipe clamping apparatus 10 may be placed in the initial closed position at a location along the pipe 24 away from the leak, such that the apparatus 10 is attached securely to the pipe 24, without risk of the apparatus 10 dropping or falling from the pipe 24. The pipe clamping apparatus 10 may then be slid along the pipe 24 such that the hole or rupture is positioned between the ends of the pipe clamping apparatus 10. The high pressure leak will not be able to open the pipe clamping apparatus 10 due to the engagement of the latch 38 with the detent 36. Additionally, the flow of fluid from the leak may pass over the seals of the pipe clamping apparatus clearing them of debris and improving the integrity of the sealed joint once the pipe clamping apparatus 10 is fully closed.

The lever portion 34 can be operated in the direction of arrow A shown in FIG. 1b to fully close the clamping assembly and pipe clamping apparatus 10. The fully closed position is shown in FIG. 1c. The lever portion 34 has been operated in an over-centre locking action and holds the first and second housing members 12, 14 in the fully closed position of the pipe clamping apparatus 10. The mutually engaging sealing surfaces 20 on the first and second housing members 12, 14 are now in sealed engagement with each other, and the cylindrical pipe sealing surfaces 22 at each end of the pipe clamping apparatus 10 are now in sealed engagement with the pipe 24. An enclosed cavity 40 is formed between the housing 12, 14 and the surface of the pipe 24. The cavity 40 is formed by the two internal cavities defined by the first and second housing members 12, 14. The cavity 40 therefore forms an annulus around the pipe 24. By defining the cavity 40 around the pipe 24, the pipe clamping apparatus 10 is able to be placed around leaking pipes in which the leak has resulted in an outwardly protruding pipe wall or swollen pipe diameter without a loss in seal integrity. Additionally, any protrusion in the wall of the pipe does not contact the pipe clamping apparatus 10 or the sealing surfaces 20, 22 and is therefore not able to cause any damage to them. The cavity 40 can alternatively be filled with a coolant to freeze the liquid within the pipe, in order to isolate the pipe 24, as will be described below.

FIGS. 1a to 1c show an example clamping assembly 26, 30, 36, but the invention is not limited to this clamping assembly. Any suitable method of clamping and securing the first and second housing members may be used. However the illustrated clamping assembly has been found to provide a quick and effective way of securing the first and second housing members in a fluid-tight manner around a pipe, and the over-centre locking action of the lever portion 34 holds the first and second housing members 12, 14 in the fully closed position in a manner which requires a positive force to be applied to the lever portion to open the pipe clamping apparatus from the fully closed position. The fully closed position is therefore a stable position.

The clamping assembly 26, 30, 36 is shown schematically in FIGS. 1a to 1c. In practice there may be a single linkage member 26 or two or more linkage members 26 arranged parallel to each other, and a single clasp arm 30 or two or more clasp arms 30 arranged parallel to each other. In a preferred embodiment there are three clasp arms 30 pivotally connected to two linkage members 26. Two latch portions 38 extend laterally between the clasp arms 30 and engage with two detent portions 36 on the second housing member 14, as shown in the illustrated embodiment of FIGS. 2 to 8.

Use of a Pipe Clamping Apparatus to Contain a Fluid Leaking from a Pipe

Referring now to FIGS. 2 to 8 and 13 there is shown a pipe clamping apparatus 110 according to the present invention which can be used to contain a fluid leaking from a pipe at a leak location 90, referred to as a pipe repair embodiment. An example leak location is shown in FIG. 4. However in practice the leak may occur at any location on the pipe, for example not at a joint or fitting, not just at the illustrated location 90. The first 12 and second 14 housing members are connected by a hinge. FIGS. 2 to 6 show the pipe clamping apparatus 110 in a fully closed position in which the first 12 and second 14 housing members are placed on the surface of the pipe 24 to define an enclosed cavity between the first and second housing members 12, 14 and the surface of the pipe 24. The first and second housing members 12, 14 are each provided with planar mutually engaging sealing surfaces 20, best seen in the open positions of FIGS. 7 and 8. The sealing surfaces 20 provide a fluid tight seal between the first and second housing members 12, 14. At least one of the mutually engaging sealing surfaces 20 has a first resilient seal means 72a secured thereto. In this example the first resilient seal means 72a is a seal comprising a strip of resilient material having a Shore A hardness in the range 30 to 90, preferably 40 to 80. It is housed in a first groove 70a which extends along the sealing surface. The first resilient seal means 72a can be provided on the sealing surface 20 of only one of the housing members 12, 14, with the sealing surface 20 of the other housing member being a planar surface adapted to mate with the first resilient seal means 72a.

Alternatively a first groove 70a and a first resilient seal means 72a can be provided on the sealing surfaces 20 of both housing members 12, 14, as illustrated in the example of FIG. 13. They can be arranged to seal against each other or to seal against planar portions of the opposite sealing surface 20.

In the example illustrated in FIG. 13 the upper groove 70a on the second housing 14 has a C-shaped seal forming a first resilient seal means 72a fixed therein, while the lower groove 70a on the first housing 12 has a flatter seal forming a first resilient seal means 72a fixed therein. Any suitable seal shapes may be used for the first resilient seal means 72a. As can also be seen in FIG. 13, the walls of the upper and lower grooves 70a may taper inwardly such that the grooves are wider at their base than at where they meet their respective sealing surfaces 20. This taper, allied with the shape of the seals, is beneficial for retaining the seal in the groove without bonding or being otherwise stuck in place and stops the seal from being ejected from the groove when closing the clamp at high pressures. Whilst holding in the seals this tapered groove still allows the seal to move freely and this has its advantages over a bonded in seal, allowing some of the seal to be more swollen than other parts on an uneven surface it is to seal against.

The first and second housing members 12, 14 are each provided at each end with pipe sealing surfaces 22, which are generally semi-cylindrical in shape. Each pipe sealing surface 22 is provided with a second resilient seal means 72b secured thereto. In this example the second resilient seal means 72b is also a seal comprising a strip of resilient material having a Shore A hardness in the range 30 to 90, preferably 40 to 80. It is housed in a second groove 70b, best seen in FIGS. 4, 7 and 8, which extends along the sealing surface 22, to provide a fluid tight seal between the external surface of the pipe 24 and the housing member 12, 14.

The first and second housing members 12, 14 are also each provided with cylindrical friction surfaces 23 adapted to provide a frictional resistance against axial and/or rotational movement of the pipe clamping apparatus 110 relative to the pipe 24. Each cylindrical friction surface 23 has a resilient friction means 68 secured thereto. In this example the resilient friction means 68 is a strip of resilient material having a Shore A hardness in the range 50 to 150, but selected so that its Shore A hardness is greater than that of the first and second resilient seal means 72a, 72b. The resilient friction means 68 is held in a friction groove 66 formed in the friction surface 23. The cylindrical pipe sealing surfaces 22 and the cylindrical friction surfaces 23, which are axially spaced from each other, are accommodated in semi-cylindrical collar sections 64 which extend from each end of the housing members 12, 14, and which together in the fully closed position form a collar which fits around the pipe 24.

Preferably the cylindrical pipe sealing surfaces 22 are arranged inside and parallel to the cylindrical friction surfaces 23. In this way the pipe sealing surfaces 22 protect the friction surfaces 23 from any fluid leaking from the pipe because the pipe sealing surfaces 22 seal against the pipe 24 and prevent any leaking fluid from reaching the friction surfaces 23. Furthermore, the frictional resistance of the friction surfaces 23 to axial and/or rotational forces is not adversely affected by the presence of any fluid leaking from the pipe 24 reaching the friction surfaces 23.

The resilient friction means 68 may be discontinuous in the circumferential direction in the closed position of the pipe clamping apparatus 110, to allow the passage of any leaking fluid therethrough between the pipe 24 and the cylindrical friction surfaces 23.

The resilient friction means 68 serves the function of holding the pipe clamping apparatus 110 on the pipe 24, while the resilient seal means 72a, 72b serves the function of providing a fluid-tight seal. Because the functions are different, different materials can be used. The properties of the resilient friction means 68 can be optimised to minimise movement of the pipe clamping apparatus on the pipe, even where the pipe is subject to vibration or other external forces. The resilient friction means 68 may be of natural or synthetic rubber, rope, resin, metal coil, chain or fire resistant barrier material. The resilient friction means 68 may be a porous but stiff material which forms a high pressure leak safety pressure reducing breaker seal. The properties of the resilient seal means 72a, 72b can be optimised to minimise leakage, without having to select a material which can accommodate and resist vibration or other forces which may urge the pipe clamping apparatus 110 to be displaced along the pipe 24. The resilient seal means 72a, 72b may be of natural or synthetic rubber, such as an elastomer having a Shore A hardness of 50-80. The resilient seal means 72a, 72b may be formed of a setting material which is placed in grooves 70a, 70b formed in the sealing surfaces 20, 22 of the housing members 12, 14.

One of the housing members, in this example the first housing member 12, is provided with a vent valve 62 allowing venting of fluid from the enclosed cavity. The vent valve 62 would be closed when effecting a repair of a pipe, but could be opened thereafter to release pressure from the pipe.

The internal surfaces 12a, 14a of the first and second housing members 12, 14 which form the outer wall of the enclosed cavity 40 are substantially semi-cylindrical in shape. The diameter Dc of the cylindrical pipe sealing surfaces 22 is approximately equal to the external diameter Dp of the pipe. The diameter Di of the semi-cylindrical internal surfaces 12a, 14a is greater than the external diameter Dp of the pipe, typically at least 1.2 or 1.5 times the diameter Dp of the pipe. In one example a pipe clamping apparatus 110 for a pipe with an external diameter Dp of 50 mm has an internal diameter Di of 100 mm. As a result, the cavity 40 formed between the housing 12, 14 and the surface of the pipe 24 allows the housing to be fitted over a section of leaking or burst pipe where there is an external fitting, such as a bolted or welded connection or a joining collar 74 as shown in FIG. 4, or where the outer wall is protruding, or where the diameter of the pipe has increased due to swelling or bulging, or where the exterior of the pipe is corroded, or where a weld joint has failed.

Although the over-centre locking action of the lever portion 34 serves to hold the pipe clamping apparatus 110 in a stable position in its fully closed position, it can be useful to prevent accidental opening of the pipe clamping apparatus by accidental operation of the lever portion 34. This can be achieved by a locking mechanism 60 operable to prevent movement of the clamping assembly 26, 30, 36 when the pipe clamping apparatus 110 is in the fully closed position. In the illustrated embodiment the locking mechanism comprises a grub screw 60 provided in a first threaded through aperture 61a on the clasp arm 30. In the fully closed position the first threaded through aperture 61a is aligned with a second threaded aperture 61b provided on the clasp arm retaining lug 27 of the first housing member 12. A locking mechanism 60 can be provided at each end of the pipe clamping apparatus 110, so that the apparatus 110 can be locked from whichever end is most convenient. Any suitable screw member 60 can be used instead of a grub screw. Alternatively a locking pin, such as a dowel or spring loaded locking pin, may be used instead of a locking screw, in which case the apertures 61a, 61b may be unthreaded.

The lever portion 34 of the clasp arm 30 includes a handle 35 to allow operation of the lever portion by hand to effect closure of the pipe clamping apparatus 110. However in industrial applications and when using the apparatus 110 to seal large pipes 24, the forces required may be greater than can be applied to the handle 35 by hand. The lever portion 34 may therefore also include a tool aperture 76, for example a slot, suitable for insertion of a lever tool, for example a crow bar or the blade of a screwdriver or the like, to enable operation of the clamping assembly 26, 30, 36 by the lever tool. The lever portion 34 may also include a tool receiving flange 78 at its edge furthest from the second pivot axis 32. In this example the tool receiving flange 78 has planar upper and lower surfaces and a constant thickness, suitable for being engaged by the jaws of a spanner, wrench, adjustable spanner or other suitable tool to enable operation of the clamping assembly 26, 30, 36 by the spanner, wrench or tool. The tool aperture 76 and/or the tool receiving flange 78 enable an operator to apply a larger lever force to close or open the clamping assembly 26, 30, 36.

### Use of a Pipe Clamping Apparatus to Isolate a Pipe by Freezing the Pipe

Referring now to FIGS. 9 to 12 there is shown a pipe clamping apparatus 210 according to the present invention which can be used to isolate a pipe 24 by freezing fluid carried in the pipe at a freezing location 92 in the pipe, referred to as a pipe freezing embodiment.

The pipe clamping apparatus 210 is opened and closed in a manner similar to the pipe clamping apparatus 110 illustrated and described in FIGS. 2 to 8. The clamping assembly 26, 30, 36 is the same, and so is not described further. The same components have the same reference numerals.

The pipe clamping apparatus 210 comprises first 12 and second 14 housing members connected by a hinge 16 and suitable for placing on a surface of a pipe 24 to define an enclosed cavity between the first 12 and second 14 housing members and the surface of the pipe 24. The clamping assembly 26, 30, 36 is operable to hold the first and second housing members in a sealed engagement with the pipe to seal the enclosed cavity 40 and provide a fluid tight seal between the housing members 12, 14 and the pipe 24, as described above with reference to FIGS. 1 to 8.

However in this embodiment the cavity 40 is not subject to such a high internal pressure, and so the requirements for the first and second resilient seal means 72a, 72b of the mutually engaging sealing surfaces 20 and the pipe sealing surfaces 22 are different. They should be able to withstand low temperatures but they do not need to be able to resist such high pressure differences across the seals. A typical material for the first and second resilient seal means 72a, 72b is a cellular foam material, such as nitrile rubber. Armaflex® tape or sheet may be used for the first and second resilient seal means 72a, 72b. It may be applied to one or both of the mutually engaging sealing surfaces 20. It may be applied to the semi-cylindrical pipe sealing surfaces 22. Alternatively first and second resilient seal means 72a, 72b may be provided as described above with reference to the pipe repair embodiment.

Depending on the environment in which the pipe clamping apparatus 210 is used to freeze the fluid in the pipe, there may not be a need for a friction surface 23 at each end of the apparatus 210. In this case the friction groove 66 and resilient friction means 68 may be omitted. The housing sleeve portions 64, which accommodate the friction surfaces 23 at each end of the apparatus 210, may also be omitted. However where the freezing apparatus 210 may be subject to large forces, for example from vibration, the friction surfaces 23 and the resilient friction means 68 provided thereon may be maintained.

Each of the first and second housing members 12, 14 are provided with an inlet 220 for attachment to a source of liquid refrigerant, the inlet 220 being in communication with the enclosed cavity 40. If an inlet 220 is provided on each housing member 12, 14 an operator has a choice of locations for attachment of the source of liquid refrigerant. The inlet 220 which is not used may be closed by a removable cap (not shown). However in some embodiments it may be sufficient to provide an inlet 220 on one housing member 12, 14 only.

Similarly each of the first and second housing members 12, 14 is provided with an outlet 222 for removal of liquid refrigerant, the outlet 222 being in communication with the enclosed cavity 40, giving the operator a choice of locations for venting liquid refrigerant from the cavity 40. The outlet 222 which is not used may be closed by a removable cap 223. However in some embodiments it may be sufficient to provide an outlet 222 on one housing member 12, 14 only.

The cavity 40 contains a heat reflecting foil 224 and an absorbent material 226 adapted to hold and at least partially retain liquid refrigerant introduced into the cavity 40 through the inlet 220. The heat reflecting foil 224 extends around the interior of the cavity 40, including the semi-cylindrical walls and the end walls of the housing members 12, 14. The heat reflecting foil 224 is fixed to the inside of each housing member 12, 14, and the absorbent material 226 is fastened to the heat reflecting foil 224 so that in use, when the apparatus 210 is in the fully closed position, the absorbent material 226 fills the cavity 40 between the heat reflecting foil 224 and the pipe 24.

By holding the housing members 12, 14 in sealed engagement with the pipe 24, the clamping assembly 26, 30, 36 compresses the mutually engaging sealing surfaces 20 of the housing members 12, 14 together with the resilient seal means 72a therebetween. At the same time the clamping assembly 26, 30, 36 urges the cylindrical pipe sealing surfaces 22 against the surface of the pipe, so that there is a fluid-tight seal provided by the resilient seal means 72b between the housing 12, 14 and the surface of the pipe 24. The production of the seal serves to contain the liquid refrigerant 94 introduced into the cavity 40 formed within the pipe clamping apparatus 210.

The absorbent material 226 may be a foam, a sponge-like material, a mineral wool, or a glass wool. The absorbent material 226 may be a foil backed mineral wool 228, such as Rockwool®. If the absorbent material is a foil backed material 228, the foil backing 230 is preferably placed adjacent to the heat reflecting foil 224, so that in use the mineral wool of the foil backed material 228 is adjacent to and in close engagement with the pipe 24. This retains the liquid refrigerant 94 next to the pipe 24 and ensures slower release of the boiling gas so that the pipe remains as cold as possible.

The heat reflecting foil 224 is a reflective membrane with high thermal performance, a cryogenic foil, a cryogenic paper, a cryogenic foil/paper composite, an aluminium foil or similar. A suitable heat reflecting foil 224 is Reflectashield® manufactured by Proctor Group.

The heat reflecting foil 224 is provided with apertures 232, best seen in the cross-sectional view of FIG. 12, corresponding to the one or more inlets 220 and one or more outlets 222. The absorbent material 226 is provided with apertures 234 corresponding to the one or more inlets 220, but there are no apertures in the absorbent material 226 at the outlets. Instead the absorbent material 226 extends across and at least partially covers the one or more outlets. This arrangement allows the liquid refrigerant to pass easily through the heat reflecting foil 224 at the inlet and reach the full depth of the absorbent material 226 through the aperture 234 in the absorbent material 226. The absorbent material 226 therefore retains the evaporating fluid and holds it against the pipe wall, making the pipe freeze faster. From there it can flow throughout the absorbent material 226 along the length and around the annulus of the internal cavity 40. As it turns to vapour it finds a path around the absorbent material 226 to the outlet 222.

The inner surface of the first and second housing members 12, 14 may be provided with local projections 236, such as pins or dowels, at least partially surrounding each outlet 222. The projections 236 are shown in FIG. 12. The purpose of the projections 236 is to provide a clearance between the absorbent material 226 and the outlet 222 so that the absorbent material 226 does not block the outlet. This is particularly necessary if the absorbent material 226 is a foil-backed mineral wool 228, since without the local projections the foil backing 230 may block the outlet 222.

The liquid refrigerant 94 is a liquid gas with a boiling temperature of less than −70° C., preferably less than −150° C. A suitable liquid refrigerant is liquid nitrogen. Liquid carbon dioxide can also be used,

As shown in FIG. 11 the pipe clamping apparatus 210 may include an insulated jacket or housing 240 which substantially surrounds the first and second housing members 12, 14, in order to further insulate the pipe clamping apparatus 210 and improve the freezing effect on the pipe 24. An insulated inlet pipe 238 may be used to convey liquid refrigerant 94 from a source, such as a pressurised tank or bottle of liquid refrigerant, to the inlet 220 and through the inlet to the cavity 40, as shown by arrow 96. An insulated outlet pipe 242 may be connected to the outlet 222 at its first end and in communication with a cavity 244 between the insulated jacket 240 and the first and second housing members 12, 14 at its second end. In this way maximum use is made of the refrigerant properties of the liquid refrigerant to cool the pipe clamping apparatus 210 and the pipe 24.

Alternatively the insulated jacket 240 may also enclose the outlet 222 through which the vaporised liquid refrigerant 94 exits the cavity 40. In this case a cover member (not shown) may partially cover the outlet 222 so that the vaporised liquid refrigerant 94 is diverted laterally within the 244 cavity between the insulated jacket 240 and the first and second housing members 12, 14. A secondary exhaust (not shown) may also be provided to take the nitrogen or other gas of the refrigerant away to an external venting point, to prevent the build-up of gas in an enclosed room or space. The insulated jacket or housing 240 may be made of any suitable insulating material, including expanded polystyrene, expanded foam, cellular plastic or card materials, glass wool or insulating fibre. The positions of the inlet 220 and oulet 222 may be varied. For example the positions of the inlet 220 and outlet 222 illustrated in the first housing 12 of FIG. 11 may be reversed.

As an alternative to an external jacket, or in addition, the housing members 12, 14 could be formed with a rigid or semi-rigid cellular structure, or could be voided with one or more openings to the inner cavity 40. The voided housing members 12, 14 could be manufactured by 3D printing or by traditional cast and CNC machining.

The housing members 12, 14 may include sections, corridors, cellular or honeycomb type structures within the housing walls, allowing the gas to circulate in the clamp walls before exiting. This would improve the efficiency of the thermal transfer and would allow more of the cold gas to be used before it leaves the apparatus 210. An example of a voided housing member 12 is shown in FIGS. 14 and 15. A number of longitudinal passages 250 extend within the body of the housing 12. They are linked by transverse passages (not shown) to form a network of cavities within the body of the housing 12. An network inlet 252 provides a passage of communication between the enclosed cavity 40 of the housing and the passages 250, while a network outlet 254 provides a passage of communication between the passages 250 and the outlet 222. The liquid refrigerant, now in the gaseous phase, can pass behind the absorbent material 226 and/or heat reflecting foil 224, through the network inlet 252, into the network of passages 250 and finally out though the network outlet 254 and housing outlet 22. As it does so it keeps the housing cool, thereby obtaining maximum refrigeration effect from the liquid refrigerant.

The following options apply to both embodiments of a pipe clamping apparatus used to contain a fluid leaking from a pipe and embodiments of a pipe clamping apparatus used to isolate a pipe by freezing the pipe.

The housing members 12, 14 may, for example, be manufactured from: a 30% glass reinforced nylons (polyamide) such as R530H; a 35% glass reinforced nylons (polyamide) such as Zytel (RTM); or acetal (POM) co-polymers such as Hostaform (RTM) C9021 or Hostaform (RTM) C2521, or any other suitable plastic material. The housing members 12, 14 may also be manufactured from metals such as steel, cast iron stainless steel or metal alloys. Thermochromic materials, composite materials and regular and advanced materials used in additive manufacture 3D printing may also be used.

Although the pipe repair and pipe freezing embodiments of the pipe clamping apparatus 10, 110, 210 have been described separately, it is envisaged that the features of the two embodiments can be combined, so that a single pipe clamping apparatus 10, 110, 210 may be used both for pipe repair applications and pipe freezing applications. Therefore the sealing surfaces 20, 22 and friction surfaces 23 described with reference to the pipe repair embodiment in FIGS. 2 to 8 and 13 may be incorporated in the pipe freezing embodiment described with reference to FIGS. 9 to 12 and 14 to 15. The heat reflecting foil 224 and absorbent material 226 described with reference to the pipe freezing embodiment may be provided separately and installed in the pipe clamping apparatus 10, 110, 210 when it is to be used in a pipe freezing application.

In other embodiments, the clamping assembly may comprise other fastening means. For example, the fastening means may be a ratchet and pawl system, or the like. The ratchet may be a linear ratchet connected to one of the first and second housing members 12, 14. The pawl may be connected to the other of the first and second housing members 12, 14. The ratchet and pawl may be manually operated by inserting the linear ratchet through the pawl. Pressure applied to close the pipe clamping apparatus will engage the elements of the linear ratchet with the pawl to retain the pipe clamping apparatus in a closed state and prevent it from becoming unfastened. This operation is analogous to the operation of a pair of handcuffs, or of a zip-tie.

In some embodiments the ratchet and pawl may be hand operated, with or without a lever. That is to say that the ratchet and pawl may function to close the pipe clamping apparatus when the first and second housing members are brought together manually. This action may be provided by a user of the pipe clamping apparatus with one hand, i.e. the first and second housing members may be closed together with one hand to engage the ratchet and pawl.

In other embodiments the ratchet and pawl system may also be tool operated. For example a ratchet handle may be attached to a ratchet and pawl mechanism located on the housing of the pipe clamping apparatus, operation of the handle tightening the closure of the device. In such embodiments the fastening means may include a release mechanism. The release mechanism may, for example, be a push-button release mechanism to quickly release the fastening means and allow rapid removal of the pipe clamping apparatus.

In other embodiments, the fastening means 20 may be a jubilee clip style fitment, or the like, comprising a band fitted around the entire housing, which may be tightened to hold the pipe clamping apparatus in a sealed engagement with a pipe.

It will be appreciated that other types of fastening means could also be used.

The first and second resilient seal means 72a 72b can comprise a seal of various materials. For example the seal may be manufactured using: polyether-ester elastomer (TPE-E) such as Arnitel (RTM); or thermoplastic vulcanizate (TPV) such as Santopene (RTM). Other possible materials are HNBR, FKM (Viton®), EPDM, PTFE, neoprene, resin, fibre resinous, injectable resin, water or fluid expanding materials.

In other embodiments the seal may be formed on the sealing surface 20, 22. In other embodiments the seal may be formed integrally as part of the sealing surface 20, 22. In further embodiments the seal may form a “tongue-and-groove” arrangement, wherein a male portion of the seal (the tongue) formed on one of the first or second housing members 12, 14 interacts with a female portion of the seal (the groove) formed on the other of the first or second housing members 12, 14.

In some embodiments, the seal of the first and second resilient seal means 72a 72b may be removable. A removable seal allows replacement of the seal for different uses of the pipe clamping apparatus 10, 110, 210. For example, if a system contains steam or hot fluids then a seal may be fitted that will have a high resistance to heat. If a system contains chemical fluids then an appropriate seal with resistance to the particular fluid may be used. Also, if a high pressure system is encountered then a more rigid seal may be used.

In some embodiments, the sealing means of the first and second resilient seal means 72a 72b may comprise two or more separate seals of the same or different materials arranged alongside each other. Furthermore, a breaker or pressure-reducing safety seal may also be provided outside of each of the first and second resilient seal means so as to limit fluid flow in the event that the first and/or second resilient seal means failed.

In some embodiments, the seal may be formed from water-expandable polymers. The seal may be formed, for example, from a urethane polymer that when water touches the surface of the polymer, water molecules arrange themselves predictably around each polymer molecule until the polymer is “full” of water. Such materials are marketed, for example, by Industrial Polymers Incorporated.

In one embodiment, the clamping apparatus may be supplied without first and second resilient seal means housed within the first and second seal grooves. Instead the first and second seals may be made from a setting material such as a silicone based sealant or a resin that is applied into the grooves as the clamping apparatus is about to be put into use upon a pipe. One or both housing members may be adapted such that one or more sealant channels are in fluid communication with the grooves, whereby sealant or resin can be pumped through the channels into the grooves once the apparatus is closed over the pipe, with the sealant or resin then allowed to cure or set to form the required seals. Alternatively, the sealant or resin can be pumped into the exposed grooves before the apparatus is closed over the pipe. This may provide a more permanent repair to contain any fluid leaking from a ruptured pipe. An additional set of grooves may be placed outside of each of the first and second grooves, thereby allowing a resilient sealing means to sit in one groove and then have a sealant or resin pumped into the other of the grooves. In this way if the resilient seal means degrades over time the more permanent sealant or resin seal will still contain any leaking fluid.

In yet further embodiments the seal may be formed to provide an electrofusion fitting in that an electrical current is used to fuse the seal to the surface of a pipe.

Other embodiments and uses of the pipe clamping apparatus are envisaged.

For example, the pipe clamping apparatus 10, 110 may be used to provide a permanent union between two sections of pipe, or to serve as a pipe fixing bracket.

Alternatively, the pipe clamping apparatus 10, 110 may be used in conjunction with electrical cables. The pipe clamping apparatus 10, 110 may be placed around damaged electrical cables to provide electrical isolation for protection and/or safety. This may prevent injury to people who may come in contact with any exposed wiring and prevent further damage to the cable. The internal cavity of the pipe clamping apparatus advantageously does not force any exposed wires together.

Alternatively, the pipe clamping apparatus 10, 110 may be used in conjunction with a pipe that is not ruptured but is intact to provide protection to the pipe and prevent it being damaged or ruptured. Alternatively, the pipe clamping apparatus may be placed around broken or damaged poles for temporary reinforcement. Alternatively, the pipe clamping apparatus may be used in thermosetting or electrofusion applications.

The pipe clamping apparatus 10, 110 can be used on pipes that have potential leaks (for example pipes which have been identified as having locally thin walls due to corrosion or wear), so that if the pipe does leak any leaking fluid will be contained. In a related embodiment, the apparatus may be adapted such that nitrogen may be pumped into the cavity to inhibit or slow oxidation of pipes.

In further uses, the pipe clamping apparatus 10, 110 may contain leaks by being fitted around: garden hoses; hydraulic pipes used in, for example, tractors or excavators; petrol pump hoses; and/or automobile radiator and/or brake pipes. This may allow a temporary repair of vehicles in remote locations.

Alternatively, the pipe clamping apparatus 110 may be used as a putty applicator whereby the cavity is filled with hardening putty and then placed around a ruptured section of pipe. The putty may then be left to harden before the pipe clamping apparatus is released leaving the putty in situ to block any leaking fluid. Resin, cement or similar could also be injected/pumped into the cavity of any of the pipe clamping apparatus described herein so that it sets hard in the cavity 40.

In alternative uses, the enclosed cavity may accommodate water treatment using a filter. For example, when the invention is used to join two open ended pipes, a filter may be located within the cavity that is able to capture particulate objects within the fluid supply. In some embodiments, the filter may be a magnetic filter capable of attracted and retaining magnetic metals. The pipe clamping apparatus may be used in potable water systems.

When the pipe clamping apparatus 110, 210 is used as part of a permanent or semi-permanent repair, part of the clamping arrangement can be removed once fitted to help reduce weight on the pipe and/or to remove the need for pipe supports. This is particularly advantageous for larger clamping apparatus, but could still be useful in temporary repair situations as well given that it results in a lighter weight and more compact device being left in situ.

It is envisaged that in certain embodiments the pipe clamping apparatus will be portable between pipework used in hydrocarbon, chemical systems and domestic heating, water and gas systems.

It is envisaged that devices disclosed herein may have uses or applications in the following areas:
Domestic water/gas systems
Commercial water/gas systems and utilities
Waste and sewage systems
Machines and appliances in factories to maintain them
Cars, trucks and other vehicles
Less developed countries or other areas where plumbers may be scarce
Oil rigs, refineries, petrochemical plants
Subsea locations
Spacecraft and other aerospace applications
Air lines
Hydraulic hoses
Chemical plants
Ships, submarines and other maritime machinery.
On steel and threaded pipework where it is difficult to repair pipes and replace joints
Fire hoses and garden hoses
Hospitals to maintain heating systems and to repair tubing connected to patients if accidentally punctured or there is a leaking fitting
Public houses for repair of perforated tubing and pipework in draft systems
Use on pipework in distilleries

The clamping mechanism may also be used as an anchor or fixture for a pipeline.

This specific description describes embodiments of the invention and is not limiting. Other embodiments of the invention will be conceivable by the skilled person without departing from the scope of the claims.

1. A pipe clamping apparatus for containing a fluid leaking from a pipe, the pipe clamping apparatus comprising:
first and second housing members connected by a hinge and suitable for placing on a surface of a pipe to define an enclosed cavity between the first and second housing members and the surface of the pipe in a fully closed position of the pipe clamping apparatus, and
a clamping assembly operable to hold the first and second housing members in a sealed engagement with the pipe to seal the enclosed cavity and provide a fluid tight seal between the housing members and the pipe,
wherein the first and second housing members are each provided with mutually engaging sealing surfaces adapted to provide a fluid tight seal between the first and second housing members, at least one of the mutually engaging sealing surfaces having a first seal groove, and
wherein the first and second housing members are each provided with pipe sealing surfaces adapted to provide a fluid tight seal between a surface of the pipe and the housing member, each pipe sealing surface having a second seal groove,
characterised in that
the first and second housing members are each provided with part-cylindrical friction surfaces separate from the pipe sealing surfaces and adapted to provide a frictional resistance against axial movement of the pipe clamping apparatus relative to the pipe, each friction surface having a resilient friction means secured thereto.

2. The pipe clamping apparatus according to claim 1, further comprising a first resilient seal means located in the first seal groove, and a second resilient seal means located in the second seal groove.

3. The pipe clamping apparatus according to claim 2, wherein the resilient friction means has a greater stiffness than the first and second resilient seal means, and optionally wherein the resilient friction means comprises an arcuate strip of resilient material having a Shore A hardness in the range 50 to 150, preferably 70 to 100.

4. The pipe clamping apparatus according to claim 2, wherein the first and second resilient seal means each comprise a strip of resilient material having a Shore A hardness in the range 30 to 90, preferably 40 to 80.

5. The pipe clamping apparatus according to claim 2, wherein the resilient friction means comprises an arcuate strip of resilient material and the first and second resilient seal means each comprise a strip of resilient material, the resilient material of the resilient friction means having a Shore A hardness greater than that of the resilient material of the first and second resilient seal means.

6. The pipe clamping apparatus according to claim 1, wherein one of the first and second housing members is provided with a vent valve allowing venting of fluid from the enclosed cavity.

7. The pipe clamping apparatus according to claim 1, wherein
the internal surfaces of the first and second housing members which form the outer wall of the cavity are substantially semi-cylindrical in shape,
the pipe sealing surfaces are substantially semi-cylindrical in shape and have a diameter approximately equal to the external diameter of the pipe, and
the diameter of the semi-cylindrical internal surfaces is greater than the external diameter of the pipe, preferably at least 1.5 times the diameter of the pipe.

8. A pipe clamping apparatus for application to a pipe for isolating the pipe by freezing fluid carried in the pipe, the pipe clamping apparatus comprising:
first and second housing members connected by a hinge and suitable for placing on a surface of a pipe to define an enclosed cavity between the first and second housing members and the surface of the pipe, and
a clamping assembly operable to hold the first and second housing members in a sealed engagement with the pipe to seal the enclosed cavity and provide a fluid tight seal between the housing members and the pipe,
wherein one of the first and second housing members is provided with an inlet for attachment to a source of liquid refrigerant, the inlet being in communication with the enclosed cavity,
wherein one of the first and second housing members is provided with an outlet for removal of evaporated liquid refrigerant, the outlet being in communication with the enclosed cavity, and
wherein the cavity contains a heat reflecting material and an absorbent material adapted to hold and at least partially retain liquid refrigerant introduced into the cavity through the inlet, the absorbent material being located in use between the heat reflecting material and the pipe.

9. The pipe clamping apparatus according to claim 8, wherein the first and second housing members are each provided with mutually engaging sealing surfaces adapted to provide a fluid tight seal between the first and second housing members, at least one of the mutually engaging sealing surfaces having a first resilient seal means secured thereto, and wherein the first and second housing members are each provided with pipe sealing surfaces adapted to provide a fluid tight seal between a surface of the pipe and the housing member, each pipe sealing surface having a second resilient seal means secured thereto.

10. The pipe clamping apparatus according to claim 8, wherein the absorbent material is a foam, a sponge-like material, a mineral wool or a glass wool.

11. The pipe clamping apparatus according to claim 8, wherein the absorbent material is a foil backed mineral wool, with the foil placed adjacent to the housing member, so that in use the absorbent material is adjacent to the pipe.

12. The pipe clamping apparatus according to claim 8, wherein the heat reflecting material is a reflective membrane with high thermal performance, such as a cryogenic foil, a cryogenic paper, a cryogenic foil/paper composite, an aluminium foil or similar.

13. The pipe clamping apparatus according to claim 8, wherein each of the first and second housing members is provided with an inlet for attachment to a source of liquid refrigerant, each inlet being in communication with the enclosed cavity.

14. The pipe clamping apparatus according to claim 8, wherein each of the first and second housing members is provided with an outlet for removal of liquid refrigerant, each outlet being in communication with the enclosed cavity.

15. The pipe clamping apparatus according to claim 8, wherein the heat reflecting material is attached to an inner surface of each of the first and second housing members.

16. The pipe clamping apparatus according to claim 15, wherein the heat reflecting material is provided with apertures corresponding to the one or more inlets and one or more outlets.

17. The pipe clamping apparatus according to claim 15, wherein the absorbent material is attached to an inner surface of the heat reflecting material.

18. The pipe clamping apparatus according to claim 17, wherein the absorbent material is provided with apertures corresponding to the one or more inlets and extends across or at least partially covers the one or more outlets.

19. The pipe clamping apparatus according to claim 18, wherein the inner surface of the first and second housing members is provided with local projections, such as pins, at least partially surrounding each outlet, thereby providing a clearance between the absorbent material and the outlet so that the absorbent material does not block the outlet.

20. The pipe clamping apparatus according to claim 8, wherein the first and second resilient seal means comprise a cellular foam material, such as nitrile rubber.

21. The pipe clamping apparatus according to claim 8, wherein the pipe clamping apparatus further comprises an insulated inlet pipe adapted to be connected to a source of liquid refrigerant and to one of the inlets for conveying liquid refrigerant to the inlet.

22. The pipe clamping apparatus according to claim 8, wherein the pipe clamping apparatus further comprises an insulated jacket which substantially surrounds the first and second housing members.

23. The pipe clamping apparatus according to claim 22, wherein the pipe clamping apparatus further comprises an outlet pipe connected to one of the outlets at its first end and in communication with a cavity between the insulated jacket and the first and second housing members at its second end.

24. The pipe clamping apparatus according to claim 1, wherein the clamping assembly comprises:
a linkage member pivotally connected at a first pivot axis to the first housing member,
a clasp arm pivotally connected to the linkage member at a second pivot axis parallel to and spaced from the first pivot axis, and
a detent portion provided on the second housing member,
wherein the clasp arm comprises a lever portion and a latch portion, the lever portion being operable to engage the latch portion with the detent portion to hold the first and second housing members in the fully closed position of the pipe clamping apparatus.

25. The pipe clamping apparatus according to claim 24, wherein the pipe clamping apparatus further comprises a locking mechanism operable to prevent movement of the clamping assembly when the pipe clamping apparatus is in the fully closed position.

26. The pipe clamping apparatus according to claim 25, wherein the locking mechanism comprises a screw member provided in a first threaded aperture on the clasp arm which is engageable with a second threaded aperture provided on the first housing member.

27. The pipe clamping apparatus according to claim 24, wherein the lever portion comprises a tool aperture, for example a slot, suitable for insertion of a lever tool to enable operation of the clamping assembly by a lever tool.

28. The pipe clamping apparatus according to claim 24, wherein the lever portion comprises a tool receiving flange at its edge furthest from the second pivot axis, the tool receiving flange being suitable to be engaged by the jaws of an adjustable spanner to enable operation of the clamping assembly by the spanner.

29. A method of using the pipe clamping apparatus according to claim 1, to contain a fluid leaking from a location in a pipe, the method comprising:
placing the first and second housing members around the pipe at the location, such that the first and second housing members at least partially enclose the pipe at the location,
operating the clamping assembly to close the first and second housing members around the pipe to define an enclosed cavity between the first and second housing members and the surface of the pipe in a fully closed position of the pipe clamping apparatus, and
operating the clamping assembly to hold the first and second housing members in a sealed engagement with the pipe to seal the enclosed cavity and provide a fluid tight seal between the housing members and the pipe,
such that the mutually engaging sealing surfaces provide a fluid tight seal between the first and second housing members, the pipe sealing surfaces provide a fluid tight seal between a surface of the pipe and each housing member, and the friction surfaces provide a frictional resistance against axial movement of the pipe clamping apparatus relative to the pipe.

30. A method of using the pipe clamping apparatus according to claim 8 to isolate a pipe at a location by freezing fluid carried in the pipe at the location, the method comprising:
placing the first and second housing members around the pipe at the location, such that the first and second housing members at least partially enclose the pipe at the location,
operating the clamping assembly to close the first and second housing members around the pipe to define an enclosed cavity between the first and second housing members and the surface of the pipe in a fully closed position of the pipe clamping apparatus, and
operating the clamping assembly to hold the first and second housing members in a sealed engagement with the pipe to seal the enclosed cavity and provide a fluid tight seal between the housing members and the pipe,
introducing liquid refrigerant into the cavity through the inlet in one of the first and second housing members and through the heat reflecting material,
passing the liquid refrigerant through the absorbent material such that the liquid refrigerant is substantially dispersed throughout the absorbent material and is in contact with the pipe at the location,
allowing the liquid refrigerant to leave the cavity through the outlet in one of the first and second housing members.

31. The method according to claim 30, wherein the liquid refrigerant is a liquid gas with a boiling temperature of less than −70° C., preferably less than-150° C.

32. The method according to claim 31, wherein the liquid refrigerant is liquid nitrogen.
